(19) United States
(12) Patent Application Publication
(10) Pub. No.: US 2018/0305588 A1
(43) Pub. Date: Oct. 25, 2018

(54) AQUEOUS BONDING COMPOSITION

(71) Applicant: HENKEL AG & CO. KGAA, Duesseldorf (DE)

(72) Inventors: Tsuyoshi TAMOGAMI, Osaka (JP); Yoshio YOSHIDA, Osaka (JP)

(21) Appl. No.: 16/010,620

(22) Filed: Jun. 18, 2018

Related U.S. Application Data
(63) Continuation of application No. PCT/JP2016/005131, filed on Dec. 14, 2016.

(30) Foreign Application Priority Data
Dec. 18, 2015 (JP) 2015-247280

(51) Int. Cl. C09J 103/00; C09J 11/04; B27N 3/00

(52) U.S. Cl. CPC C09J 103/00; C09J 2400/16; B27N 3/002; C09J 11/04

(57) ABSTRACT

Disclosed is an aqueous bonding composition comprising: (A) a sugar syrup; (B) an inorganic acid ammonium salt; and (C) a metal salt. The sugar syrup (A) preferably comprises at least one selected from waste molasses, ice molasses, and crude saccharide. The metal salt (C) preferably comprises at least one selected from potassium salts, calcium salts, sodium salts, and magnesium salts. The aqueous bonding composition is excellent in balance among performances such as bending strength, bending strength under wet condition, water-absorption thickness expansion coefficient, and peeling strength while being capable of bonding at a comparatively low temperature, and is particularly useful to produce a wood-based material. Further, disclosed is a wood-based material obtainable by using the composition.

### CROSS-REFERENCE TO RELATED APPLICATIONS

This application claims benefit under Paris Convention of Japanese Patent Application No. 2015-247280 filed on Dec. 18, 2015, incorporated herein by reference in its entirety.

### TECHNICAL FIELD

The present invention relates to an aqueous bonding composition capable of producing an aqueous adhesive, and a wood-based material which is producible by using the aqueous bonding composition.

### BACKGROUND ART

Wood-based materials (for example, plywoods (veneer board, etc.), particle boards, fiber boards (medium density fiber board MDF, etc.), and laminated woods) are generally produced by applying or spraying an adhesive onto wood-based elements (raw materials) (for example, various sizes of fibers, small pieces, and veneers obtained by finely dividing woods or herbaceous plants), followed by optional molding through pressurizing and heating. Wood-based materials are naturally regenerable, and whose size and stability of strength are enhanced and thus defects peculiar to woods are removed while utilizing advantages of woods. From the viewpoint of the protection of the earth environment, the protection of workers producing wood-based materials, and the prevention of sick house syndrome, there have been developed, as the adhesive to be used, an aqueous adhesive which does not cause diffusion of formaldehyde and contains no organic solvent.

When a wood-based material (for example, particle board) is produced using a urea resin and a phenol resin, a mixture of a wood-based element and an adhesive is prepared, and the mixture is generally heated to a temperature in a range of about 130 to 170° C. and then molded. Therefore, it is preferable that, even though an aqueous adhesive is used, the mixture containing the adhesive is heated to approximately the same temperature, thus which makes it possible to produce the wood-based material. However, when using the aqueous adhesive, higher temperature is often needed.

There is also a need that the wood-based material thus obtained (for example, particle board) is excellent in properties such as bending strength, bending strength under wet condition, water-absorption thickness expansion coefficient, and peeling strength. However, when using the aqueous adhesive, the properties are often unsatisfactory.

Patent Literature 1 discloses an aqueous binder comprising a reducing saccharide such as dextrose, and ammonium carboxylate such as triammonium citrate (see Patent Literature 1, claims 1 to 2 and 4 to 6, and Table 1 in [0131]). This aqueous binder is employed to produce a fiber glass and a wood-based fiber board (see Patent Literature 1, [0016] to [0017]). Considering bending strength under wet condition and water-absorption thickness expansion coefficient of these fiber materials, the binder of Patent Literature 1 is not suited for producing a structural material which is required to have severe moisture resistance.

Patent Literature 2 discloses an adhesive comprising a saccharide (sucrose, etc.) and a polyhydric carboxylic acid (citric acid, etc.) so as to bond woods (see Patent Literature 2, claims 1, 3, and 5 to 6). The adhesive of Patent Literature 2 enables to improve its bonding force between the woods by including the polycarboxylic acid. However, in the case of producing a wood-based material, the temperature increases to 200° C. and also the water-absorption thickness expansion coefficient increases to about 25% (see Patent Literature 2, Test 2 in Table 10).

Patent Literature 3 discloses a bonding composition comprising a waste molasses, potassium, and an organic sulfonic acid (see Patent Literature 3, claims 1 and 2, Tables 1, 2A, and 3A). A cedar fiber board and a bagasse chip board formed with the bonding composition of Patent Literature 3 are immersed in a warm water at 70° C. for 4 hours, and then the water-absorption expansion coefficient is measured and the hot water resistance is evaluated (see Patent Literature 3, Tables 1, 2B. and 3B). However, the board of Patent Literature 3 sometimes collapses when immersed in a hot water at a high temperature (100° C.). Therefore, it cannot be said that the board sufficiently satisfies high hot water resistance which is required in recent days.

Therefore, an aqueous adhesive has been required, which is excellent in performances such as bending strength, bending strength under wet condition, water-absorption thickness expansion coefficient, and peeling strength, and which is excellent in balance among them, while being capable of bonding at a comparatively low temperature, as an aqueous adhesive used to produce a wood-based material.

### CITATION LIST

### Patent Literature

[PTL 1] JP 2009-503193 A
[PTL 2] WO 2010/001988 A1
[PTL 3] WO 2015/056357 A1

### SUMMARY OF INVENTION

### Technical Problem

In light of these circumstances, the present invention has been made and an object thereof is to provide an aqueous bonding composition which is excellent in balance among performances such as bending strength, bending strength under wet condition, water-absorption thickness expansion coefficient, and peeling strength while being capable of bonding at a comparatively low temperature, and which is particularly useful to produce a wood-based material. Further, an object of the present invention is to provide a wood-based material which is obtainable by using the aqueous bonding composition.

### Solution to Problem

As a result of continued intensive study, the present inventors have found that an aqueous bonding composition comprising a sugar syrup, an inorganic ammonium salt, and a metal salt is excellent in balance among properties such as bending strength, bending strength under wet condition, water-absorption thickness expansion coefficient, and peeling strength while being capable of bonding at a comparatively low temperature, and which is particularly useful to produce a wood-based material, thus completing the present invention.

The present invention provides, in an aspect, an aqueous bonding composition comprising: (A) a sugar syrup; (B) an inorganic acid ammonium salt; and (C) a metal salt.

The present invention provides, in an embodiment, an aqueous bonding composition, wherein the sugar syrup (A) comprises at least one selected from waste molasses, ice molasses (or high grade molasses), and crude saccharide (or raw sugar).

The present invention provides, in another embodiment, an aqueous bonding composition, wherein the metal salt (C) comprises at least one selected from potassium salts, calcium salts, sodium salts, and magnesium salts.

The present invention provides, in a further embodiment, an aqueous bonding composition, wherein the metal salt (C) comprises at least one selected from magnesium chloride and sodium chloride.

The present invention provides, in a preferred embodiment, an aqueous bonding composition, wherein the inorganic acid ammonium salt (B) comprises at least one selected from ammonium hydrogen phosphate, ammonium dihydrogen phosphate, ammonium sulfate, and ammonium chloride.

The present invention provides, in further another embodiment, an aqueous bonding composition, wherein the composition comprises the sugar syrup (A) in an amount of 70 to 90 parts by weight based on 100 parts by weight of the total weight of the components (A) to (C).

The present invention provides, in another aspect, a wood-based material comprising an aqueous bonding composition and a wood-based element.

### Advantageous Effects of Invention

The aqueous bonding composition according to the embodiment of the present invention comprises (A) a sugar syrup, (B) an inorganic acid ammonium salt, and (C) a metal salt, and is therefore capable of bonding at a comparatively low temperature. If a material coated with the aqueous bonding composition of the present invention is processed, molded, and cured, the material is excellent in balance among properties such as bending strength, bending strength under wet condition, water-absorption thickness expansion coefficient, and peeling strength. Considering properties of the materials thus obtained, the aqueous bonding composition of the present invention is useful to produce various materials and is most suitable so as to produce a wood-based material.

### DESCRIPTION OF EMBODIMENTS

The aqueous bonding composition according to the embodiment of the present invention comprises (A) a sugar syrup, (B) an inorganic acid ammonium salt, and (C) a metal salt.

In the present invention, the “(A) sugar syrup” means a syrup prepared by removing dietary fibers and impurities from sugar raw materials such as sugarcane, sugar beet, sugar maple, and Palmyra palm, or means a viscous liquid (a molasses) obtainable when sugar is purified from raw materials, which viscous liquid also comprises components other than sugar. Namely, the sugar syrup (A) comprises a purified product of the sugar raw material.

In the present description, the sugar syrup (A) comprises “crude saccharide”. This reason is that the crude saccharide is obtained by separating waste molasses to some extent by centrifugal separation, and comprises “sugar syrup” which could not be completely separated.

Viscosity at 30° C. of the sugar syrup (A) is preferably 50 mPa·s to 5,000 mPa·s, more preferably 100 mPa·s to 3,000 mPa·s, and particularly preferably 300 mPa·s to 1,500 mPa·s. As used herein, the viscosity of the sugar syrup (A) refers to a value obtained by measuring the viscosity at 30° C. using a BM type viscometer with a spindle No. 27 at a rotation number of 6 to 12 rpm.

Specific examples of the sugar syrup (A) include waste molasses, ice molasses (or high grade molasses), white honey, caramel, crude saccharide, sugar solution, and juices of sugar raw materials (sugarcane, sugar beet, sugar maple, and Palmyra palm).

In the present invention, the sugar syrup (A) preferably comprises at least one selected from waste molasses, ice molasses, and crude saccharide (or raw sugar). When using at least one selected from waste molasses, ice molasses, and crude saccharide, a material obtained by curing after being coated with the aqueous bonding composition of the present invention is excellent in bending strength, bending strength under wet condition, water-absorption thickness expansion coefficient, and peeling strength, and is particularly excellent in bending strength under wet condition and water-absorption thickness expansion coefficient.

Examples of the material obtained by using the aqueous bonding composition of the present invention include an inorganic molded member and a wood-based material, obtained by molding materials such as calcium silicate, gypsum, rock wool, concrete, cement, mortar, and slate into various forms (plate, block, etc.). In the present invention, the wood-based material is most suitable.

If the aqueous bonding composition of the present invention comprises the sugar syrup (A), the composition may comprise “other saccharide” as long as the object of the present invention is not impaired. In the present description, the “saccharide” is generally called saccharide, and may be mixed as long as the objective properties of the aqueous bonding composition of the present invention are not impaired. Examples of the saccharide include monosaccharide, disaccharide, trisaccharide, tetrasaccharide, polysaccharide, and other oligosacccharides.

Specific examples of the “monosaccharide” include the followings:

hexoses such as glucose, psicose, fructose, sorbose, tagatose, allose, altrose, mannose, gulose, idose, galactose, talose, fucose, fuculose, and rhamnose;

trioses such as ketotriose (dihydroxyacetone) and aldotriose (glyceraldehyde);

tetroses such as erythrulose, erythrose, and threose; and

pentoses such as ribulose, xylulose, ribose, arabinose, xylose, lixose, and deoxyribose.

Example of the “disaccharide” include sucrose, lactose, maltose, trehalose, turanose, and cellobiose.

Examples of the “trisaccharide” includes raffinose, melezitose, maltotriose, and 1-kestose (GF2).

Examples of the “tetrasaccharide” include acarbose, stachyose, and nystose (GF3).

Examples of the “polysaccharide” include glycogen, starch (amylose, amylopectin, etc.), cellulose, dextrin, glucan, N-acetylglucosamine, chitin, and inulin (including fructofuranosylnystose: GF4).

Examples of the “other oligosaccharides” include fructooligosaccharide, galactooligosaccharide, and mannan oligosaccharide.

In the present invention, the “(B) inorganic acid ammonium salt” is generally called an ammonium salt of an inorganic acid and is not particularly limited as long as the objective aqueous bonding composition of the present invention is obtainable.

Examples of the “inorganic acid ammonium salt” can comprise ammonium sulfate, ammonium hydrogen sulfate, ammonium halide (for example, ammonium chloride, ammonium fluoride, ammonium bromide, ammonium iodide, etc.), ammonium phosphate, ammonium hydrogen phosphate, and ammonium dihydrogen phosphate.

The “inorganic acid ammonium salt” is preferably at least one selected from ammonium sulfate, ammonium chloride, ammonium hydrogen phosphate, and ammonium dihydrogen phosphate, and ammonium hydrogen phosphate and ammonium dihydrogen phosphate are particularly preferable.

When the “(B) inorganic acid ammonium salt” is at least one selected from ammonium sulfate, ammonium chloride, ammonium hydrogen phosphate, and ammonium dihydrogen phosphate, the aqueous bonding composition of the present invention has more excellent curability, thus which makes it possible to further improve bonding properties (bending strength under wet condition and water-absorption thickness expansion coefficient) of a wood-based material.

The “inorganic acid ammonium salt(s)” can be used alone or in combination.

It is possible to use commercially available products as the “inorganic acid ammonium salt”.

In the present invention, the metal salt “(C) is a generic name of compounds in which a hydrogen atom of an acid is substituted with a metal ion. Hydrogen atoms of hydrochloric acid HCl and sulfuric acid H₂SO₄ are respectively substituted with sodium or magnesium ions to form sodium chloride NaCl and magnesium sulfate MgSO₄.

In the present invention, the metal salt (C) preferably comprises at least one selected from potassium salts, calcium salts, sodium salts, and magnesium salts.

Examples of the metal salt (C) include:

potassium salts such as potassium sulfate, potassium hydrogen sulfate, potassium halide (for example, potassium fluoride, potassium chloride, potassium bromide, and potassium iodide), potassium phosphate, potassium hydrogen phosphate, and potassium dihydrogen phosphate;

calcium salts such as calcium sulfate, potassium hydrogen sulfate, calcium halide (for example, calcium fluoride, calcium chloride, calcium bromide, and calcium iodide), calcium phosphate, calcium hydrogen phosphate, and calcium dihydrogen phosphate;

sodium salts such as sodium sulfate, sodium hydrogen sulfate, sodium halide (for example, sodium fluoride, sodium chloride, sodium bromide, and sodium iodide), sodium phosphate, sodium hydrogen phosphate, and sodium dihydrogen phosphate; and

magnesium salts such as magnesium sulfate, magnesium hydrogen sulfate, magnesium halide (for example, magnesium fluoride, magnesium chloride, magnesium bromide, and magnesium iodide), magnesium phosophate, magnesium hydrogen phosphate, and magnesium dihydrogen phosphate.

It is preferred to include, as the metal salt (C), at least one selected from potassium sulfate, potassium hydrogen sulfate, potassium chloride, potassium hydrogen phosphate, and potassium dihydrogen phosphate;

calcium sulfate, calcium hydrogen sulfate, calcium chloride, calcium hydrogen phosphate, and calcium dihydrogen phosphate;

sodium sulfate, sodium hydrogen sulfate, sodium chloride, sodium hydrogen phosphate, and sodium dihydrogen phosphate; and

magnesium sulfate, magnesium hydrogen sulfate, magnesium chloride, magnesium hydrogen phosphate, and magnesium dihydrogen phosphate.

The metal salt (C) is preferably a metal salt of a strong acid, and more preferably a metal salt of sulfuric acid and a metal halide. When the metal salt (C) is a metal salt of strong acid, pH of the aqueous bonding composition of the present invention becomes in a range of 1 to 6. In the present invention, the pH of the aqueous bonding composition is preferably in a range of 1 to 6, particularly preferably 2 to 5, and most preferably 3 to 4.5.

A wood-based material produced by using the aqueous bonding composition, which comprises a metal salt (C) of a strong acid and exhibits pH in the above range, can be cured by heating and pressurizing at a lower temperature for a shorter time.

The metal salt (C) is particularly preferably at least one selected from potassium sulfate, potassium chloride, calcium sulfate, calcium chloride, sodium sulfate, sodium chloride, magnesium sulfate, and magnesium chloride. When the metal salt (C) is at least one selected from potassium sulfate, potassium chloride, calcium sulfate, calcium chloride, sodium sulfate, sodium chloride, magnesium sulfate, and magnesium chloride, a wood-based material produced by using the aqueous bonding composition of the present invention can be cured by heating and pressurizing at a lower temperature for a shorter time, thus which makes it possible to exhibit a lower water-absorption thickness expansion coefficient and a higher bending strength under wet condition.

The metal salt (C) comprises most preferably magnesium chloride. When the metal salt (C) comprises magnesium chloride, the wood-based material of the present invention can be cured by heating and pressurizing at a lower temperature for a shorter time, thus which makes it possible to exhibit a lower water-absorption thickness expansion coefficient and a higher bending strength under wet condition.

These metal salt(s) (C) can be used alone or in combination.

It is possible to use commercially available products as the metal salt (C).

Each amount of the components (A) to (C) is not particularly limited as long as the objective aqueous bonding composition of the present invention is obtainable. The composition of each component will be shown below, but a numerical value of each component is defined as a value calculated in terms of the dehydrated solid content.

The component (A) is preferably included in an amount of 70 to 90 parts by weight, more preferably 70 to 85 parts by weight, and particularly preferably 75 to 85 parts by weight, based on 100 parts by weight of the total amount of the components (A) to (C).

The component (B) is preferably included in an amount of 5 to 20 parts by weight, more preferably 7 to 20 parts by weight, and particularly preferably 10 to 20 parts by weight, based on 100 parts by weight of the total amount of the components (A) to (C).

The component (C) is preferably included in an amount of 2 to 15 parts by weight, more preferably 3 to 15 parts by weight, and particularly preferably 5 to 15 parts by weight, based on 100 parts by weight of the total amount of the components (A) to (C).

If the component (A) is included in an amount of 70 to 90 parts by weight, the wood-based material produced by using the aqueous bonding composition of the present invention can have more excellent bending strength and bending strength under wet condition.

If the component (B) is included in an amount of 5 to 20 parts by weight, curability of the aqueous bonding composition of the present invention is improved, so that the wood-based material can be cured by heating and pressurizing at a lower temperature for a shorter time.

If the component (C) is included in an amount of 2 to 15 parts by weight, the wood-based material of the present invention may be more excellent in low-temperature curability.

The aqueous bonding composition according to the present invention comprises water, and has a form of an aqueous solution in which all of the above-mentioned components (A) to (C) are dissolved in water, or a form of a dispersion in which at least one of the above-mentioned components (A) to (C) is dispersed without being dissolved in water.

The “water” as used herein is generally called “water” and is not particularly limited as long as the objective aqueous bonding composition of the present invention is obtainable. Examples thereof can include distilled water, deionized water, pure water, tap water, and industrial water.

The amount of the water contained in the aqueous bonding composition according to the embodiment of the present invention is not particularly limited and is appropriately selected considering the components (A) to (C) to be used and additives as long as the objective aqueous bonding composition of the present invention is obtainable.

The aqueous bonding composition according to the embodiment of the present invention preferably includes water in an amount of 50 to 200 parts by weight, more preferably 70 to 180 parts by weight, and particularly preferably 80 to 160 parts by weight, based on 100 parts by weight of the total amount of the components (A) to (C).

The aqueous bonding composition according to the present invention is in a form of an aqueous solution or an aqueous dispersion, so that it is easy to apply or spray onto an adherend. Furthermore, the aqueous bonding composition according to the present invention is excellent in protection of the earth environment, and protection of the work environment of workers because an organic solvent is not preferably used.

The aqueous bonding composition according to the embodiment of the present invention can comprise other components. Examples of the component can include a thickener, a preservative, a mildew-proofing agent, a rust preventive, and a dispersion stabilizer.

The thickener is used to prevent a viscosity of the composition from decreasing in the case of pressurizing and heating, and is not particularly limited as long as the objective aqueous bonding composition of the present invention is obtainable. The thickener is classified, for example, into an organic thickener and an inorganic thickener.

Examples of the inorganic thickener can include clay, talc, and silica.

Examples of the organic thickener can include carboxymethyl cellulose, polyvinyl alcohol, and vegetable flours such as wheat flour, cornstarch, top-grade rice flour, walnut flour, and coconut flour.

These thickeners can be used alone or in combination.

The aqueous bonding composition according to the embodiment of the present invention can be produced by mixing the above-mentioned components (A) to (C), optional other components and water, followed by stirring. The order of mixing the respective components (A) to (C), water, and the other components, the mixing method, and the stirring method are not particularly limited as long as the objective aqueous bonding composition of the present invention is obtainable.

The wood-based material according to the present invention may be a mixture comprising an aqueous bonding composition according to the embodiment of the present invention and a wood-based element (raw material) (for example, fibers of wood-based or herbaceous plants, small pieces and veneers, etc.). Moreover, the concept of the wood-based material also includes those of which water is removed later. The wood-based material such as a particle board, a fiber board, or the like is produced by applying or spraying the aqueous bonding composition according to the embodiment of the present invention onto a wood-based element, and heating the wood-based element, leading to bonding of the wood-based element, followed by molding. Therefore, the present invention provides the wood-based material obtained by mixing the aqueous bonding composition with the wood-based element, followed by molding.

Examples of the wood-based element (raw material) include such as sawn boards, veneers, wood-based strands, wood-based chips, wood-based fibers and vegetable fibers, and the like obtainable, for example, by grinding woods.

Examples of the wood-based material include, for example, laminated woods, plywoods, particle boards, fiber boards, MDF, and the like obtainable by bonding the wood-based element using an adhesive.

The present invention provides a wood-based material obtainable by bonding the wood-based element using the adhesive.

The aqueous bonding composition according to the embodiment of the present invention can be used to bond various adherends (for example, papers, wood-based fibers, plywoods, etc.), and can be suitably used to produce a wood-based material.

In the case of producing the wood-based material by molding, manufacturing condition such as coating amount of the aqueous bonding composition, coating method, molding pressure, molding temperature, and molding time are appropriately selected according to the type, shape, and size of the wood-based element, the size of the wood-based material to be produced, and are not particularly limited as long as the objective wood-based material of the present invention is obtainable.

The coating amount of the aqueous bonding composition is preferably in a range of 5 to 80 parts by weight, more preferably 10 to 60 parts by weight, and particularly preferably 20 to 40 parts by weight, based on 100 parts by weight of a dried wood-based element.

The coating method of the aqueous bonding composition is preferably a coating method using a roll and a brush, a spraying method using a spray, a method of impregnating with the aqueous bonding composition, or the like.

The molding pressure is preferably in a range of 0.5 to 6.0 MPa. If the molding pressure is 6.0 MPa or less, the wood-based material is scarcely degraded since too large pressure is not applied. If the molding pressure is 0.5 MPa or more, it is possible to satisfactorily bond the wood-based element.

The molding temperature is preferably in a range of 140 to 230° C., more preferably 140 to 200° C., and particularly preferably 140 to 180° C. If the molding temperature is 230° C. or lower, low energy consumption is achieved because of non-excessive temperature, and also the wood-based material is scarcely degraded. If the molding temperature is 140° C. or higher, the bonding can proceed within an appropriate time.

The molding time is preferably in a range of 3 to 10 minutes, more preferably 3 to 9 minutes, and particularly preferably 3 to 7 minute. If the molding time is 10 minutes or less, low energy consumption is achieved because of non-excessive time, and also the wood-based material is scarcely degraded. If the molding time is 3 minutes or more, an appropriate bonding time is secured, thus which makes it possible to secure appropriate bonding.

The wood-based material thus obtained in the above-mentioned manner can be used for various applications, for example, building materials, furniture, and so on, like a conventional wood-based material.

### EXAMPLES

The present invention will be described below by way of Examples and Comparative Examples. It should be noted, however, these Examples are intended to describe the present invention and the present invention is not limited thereto.

The following components were prepared as components of an aqueous bonding composition. Trade name and manufacturer's name are shown in parentheses. Parts are by weight.

<(A) Sugar syrup>

(A-1) Waste molasses (Hayashi shokai, Molasses H (trade name)), Viscosity (30° C.): 1000 mPa·s

(A-2) Ice molasses (Hayashi shokai, Ice molasses (trade name)), Viscosity (30° C.): 750 mPa·s

(A-3) Crude saccharide, Viscosity (30° C.): not measured due to solid form of (A-3)

(A′-4) Glucose (Wako Pure Chemical Industries, Ltd., Glucose (trade name))

### <(B) Inorganic Acid Ammonium Salt>

(B-1) Ammonium dihydrogen phosphate (Wako Pure Chemical Industries, Ltd.)

(B-2) Ammonium hydrogen phosphate (Wako Pure Chemical Industries, Ltd.)

(B′-3) Paratoluenesulfonic acid (Wako Pure Chemical Industries, Ltd.

(B′-4) Ammonium citrate (Wako Pure Chemical Industries, Ltd.)

### <(C) Metal Salt>

(C-1) Magnesium chloride (Wako Pure Chemical Industries, Ltd.)

(C-2) Sodium chloride (Wako Pure Chemical Industries, Ltd.)

(C-3) Potassium chloride (Wako Pure Chemical Industries, Ltd.)

Aqueous bonding compositions of Examples 1 to 11 and Comparative Examples 12 to 17 were produced in the following manner.

### [Example 1] Production of Aqueous Bonding Composition

128 Parts (solid content of 80 parts) of an aqueous solution of (A-1) a waste molasses (molasses H), 10.0 parts of (B-1) ammonium dihydrogen phosphate (Wako Pure Chemical Industries, Ltd.), and 10.0 parts of (C-1) magnesium chloride (Wako Pure Chemical Industries, Ltd.) were mixed and the mixture was added to distilled water, followed by dissolving the mixture with stirring at normal temperature to obtain an aqueous bonding composition of Example 1.

With respect to the aqueous bonding composition of Example 1, as shown in Table 1, the total weight of the components (A-1), (B-1), and (C-1) was 100 parts, and the weight of water was 150 parts.

Regarding numerical values of the component (A-1) shown in Table 1, only the solid content is shown.

### [Examples 2 to 11] and [Comparative Examples 12 to 17] Production of Aqueous Bonding Composition

Each composition of the aqueous bonding compositions of Examples 2 to 11 and Comparative Examples 12 to 17 is shown in Table 1 and Table 2.

In the same manner as in Example 1, except that the components (A), (B), and (C) used in Example 1 were changed to the components and amounts thereof shown in Table 1 and Table 2, the aqueous bonding compositions of Examples 2 to 11 and Comparative Examples 12 to 17 were produced.

Regarding numerical values of the component (A) shown in Tables 1 and 2, only the solid content (sugar syrup) is shown, and does not comprise moisture.

TABLE 1

| Bonding | | Examples | | | | | | | | |
|---|---|---|---|---|---|---|---|---|---|---|
| composition | | 1 | 2 | 3 | 4 | 5 | 6 | 7 | 8 | 9 |
| (A) | (A-1) | 80.0 | 80.0 | 80.0 | 80.0 | 80.0 | | | | |
| | (A-2) | | | | | | 80.0 | 80.0 | | |
| | (A-3) | | | | | | | | 80.0 | 80.0 |
| (B) | (B-1) | 10.0 | | 10.0 | | | 10.0 | 10.0 | 10.0 | 10.0 |
| | (B-2) | | 10.0 | | 10.0 | 10.0 | | | | |
| | (B'-3) | | | | | | | | | |
| | (B'-4) | | | | | | | | | |
| (C) | (C-1) | 10.0 | 10.0 | | | | 10.0 | | 10.0 | |
| | (C-2) | | | 10.0 | 10.0 | | | 10.0 | | 10.0 |
| | (C-3) | | | | | 10.0 | | | | |

| | | | | | | | | | |
|---|---|---|---|---|---|---|---|---|---|
| Water | 150.0 | 150.0 | 150.0 | 150.0 | 150.0 | 150.0 | 150.0 | 150.0 | 150.0 |
| pH | 3.5 | 4.6 | 4.0 | 4.7 | 5.7 | 3.3 | 4.0 | 3.0 | 3.6 |
| Total solid content | 40.0 | 40.0 | 40.0 | 40.0 | 40.0 | 40.0 | 40.0 | 40.0 | 40.0 |
| of composition | | | | | | | | | |
| (%) | | | | | | | | | |
| (A) + (B) + (C) | 100.0 | 100.0 | 100.0 | 100.0 | 100.0 | 100.0 | 100.0 | 100.0 | 100.0 |

TABLE 2

| Bonding | | Examples | | Comparative Examples | | | | | |
|---|---|---|---|---|---|---|---|---|---|
| composition | | 10 | 11 | 12 | 13 | 14 | 15 | 16 | 17 |
| (A) | (A-1) | 86.2 | 72.7 | 88.9 | 88.9 | 80.0 | 80.0 | 72.7 | |
| | (A-2) | | | | | | | | |
| | (A-3) | | | | | | | | |
| | (A'-4) | | | | | | | | 80 |
| (B) | (B-1) | 10.8 | 18.2 | 11.1 | | | | | 10 |
| | (B-2) | | | | 11.1 | | | | |
| | (B'-3) | | | | | 10.0 | 10.0 | 9.1 | |
| | (B'-4) | | | | | | | 9.1 | |
| (C) | (C-1) | 3.0 | 9.1 | | | 10.0 | | | 10 |
| | (C-2) | | | | | | 10.0 | 9.1 | |
| | (C-3) | | | | | | | | |

| | | | | | | | | |
|---|---|---|---|---|---|---|---|---|
| Water | 150.0 | 150.0 | 150.0 | 150.0 | 150.0 | 150.0 | 150.0 | 150.0 |
| pH | 3.89 | 3.37 | 4.2 | 7.7 | <1 | <1 | <1 | 3.2 |
| Total solid content | 40.0 | 40.0 | 40.0 | 40.0 | 40.0 | 40.0 | 40.0 | 40.0 |
| of composition (%) | | | | | | | | |
| (A) + (B) + (C) | 100.0 | 100.0 | 100.0 | 100.0 | 100.0 | 100.0 | 100.0 | 100.0 |

Using the above-mentioned aqueous bonding compositions of Examples 1 to 11 and Comparative Examples 12 to 17, wood-based materials (particle boards) of Examples 18 to 30 and Comparative Examples 31 to 37 were produced.

### [Example 18] Production of Wood-Based Material

Wood-based fibers of coniferous tree, which passed through a 60 mesh sieve, were used as a wood-based element (raw material). The aqueous adhesive composition of Example 1 was uniformly applied onto 72 parts of the wood-based element using a spray so that the solid content became 24 parts. The coated wood-based element was dried in an oven at 80° C. for 2 hours. After press molding at a heating platen temperature of 170° C. under a pressure of 4 MPa for 9 minutes, a wood-based material (particle board) having a thickness of 9 mm and a density of 0.8 g/cm³ of Example 18 was produced. The composition and manufacturing conditions used in Example 18 are shown in Table 3.

### [Examples 19 to 30] and [Comparative Examples 31 to 37] Production of Wood-Based Material

Each composition and manufacturing condition used to produce particle boards of Examples 19 to 30 and Comparative Examples 31 to 37 are shown in Tables 3 and 4.

In the same manner as in Example 18, except that the aqueous adhesive composition used in Example 18, the amount thereof, the amount of the wood-based element, and press molding conditions (heating platen temperature, pressure, and molding time) were changed to the values shown in Tables 3 and 4, wood-based materials (particle boards) of Example 19 to 30 and Comparative Example 31 to 37 were produced. Other conditions such as size and density of each particle board are the same as those of the particle board of Example 18.

Regarding the particle boards thus obtained, the respective bending strength (N/mm²), bending strength under wet condition (B test) (N/mm²), water-absorption thickness expansion coefficient (%), and peeling strength (N/mm²) were measured in accordance with JISA5908:2003.

The above-mentioned particle board corresponds to a “non-polished board” of a “base particle board” disclosed in JISA5908:2003. The “bending strength(s)” in a width direction is almost the same as that in a length direction, and smaller values were employed as the results of the “bending strength” and the “bending strength under wet condition”.

Evaluation criteria of each test are as follows.

### <Evaluation Criteria for Bending Strength>

A: Strength is 16 N/mm² or more.
B: Strength is 13 N/mm² or more and less than 16 N/mm².
C: Strength is less than 13 N/mm².

### <Evaluation Criteria for Bending Strength Under Wet Condition>

A: Strength is 7.0 N/mm² or more.
B: Strength is 6.5 N/mm² or more and less than 7.0 N/mm².
C: Strength is less than 6.5 N/mm².

### <Evaluation Criteria for Water-Absorption Thickness Expansion Coefficient>

A: Expansion coefficient is 6% or less.
B: Expansion coefficient is more than 6% and 12% or less.
C: Expansion coefficient exceeds 12% or particle board collapses.

### <Evaluation Criteria for Peeling Strength>

Good (Go): Strength is 0.2 N/mm² or more.
Bad (Ba): Strength is less than 0.2 N/mm².

TABLE 3

| | | | Examples | | | | | | | | | |
|---|---|---|---|---|---|---|---|---|---|---|---|---|
| Wood-based material | | | 18 | 19 | 20 | 21 | 22 | 23 | 24 | 25 | 26 | 27 |
| Composition | Wood-based | Parts by | 76 | 73 | 73 | 73 | 73 | 73 | 76 | 73 | 73 | 73 |
| | element | weight | | | | | | | | | | |
| | Bonding | Examples | 1 | 1 | 2 | 3 | 4 | 5 | 6 | 6 | 7 | 8 |
| | composition | | | | | | | | | | | |
| | | Parts by | 24 | 27 | 27 | 27 | 27 | 27 | 24 | 27 | 27 | 27 |
| | | weight | | | | | | | | | | |
| Molding | Temperature | ° C. | 170 | 170 | 170 | 170 | 170 | 170 | 170 | 170 | 170 | 170 |
| conditions | Time | Minutes | 9 | 9 | 9 | 9 | 9 | 9 | 9 | 9 | 9 | 9 |
| | Pressure | MPa | 4 | 4 | 4 | 4 | 4 | 4 | 4 | 4 | 4 | 4 |

| | | | | | | | | | | | |
|---|---|---|---|---|---|---|---|---|---|---|---|
| Performances | Bending strength | 18.8 | 21.2 | 18.8 | 18.4 | 16.8 | 20.5 | 18.9 | 20.5 | 17.8 | 18.8 |
| | (N/mm²) | A | A | A | A | A | A | A | A | A | A |
| | Bending strength | 7.7 | 7.5 | 7.1 | 6.7 | 6.8 | 6.8 | 7.2 | 8.2 | 7.1 | 8.3 |
| | under wet condition | A | A | A | B | B | B | A | A | A | A |
| | (N/mm²) | | | | | | | | | | |
| | Water-absorption | 9.6 | 5.4 | 8.6 | 10.4 | 9.8 | 7.0 | 5.8 | 4.5 | 7.0 | 5.1 |
| | thickness expansion | B | A | B | B | B | B | A | A | B | A |
| | coefficient (%) | | | | | | | | | | |
| | Peeling strength | 1.3 | 1.4 | 1.2 | 1.1 | 1.1 | 1.0 | 1.1 | 1.4 | 1.3 | 1.4 |
| | (N/mm²) | Go | Go | Go | Go | Go | Go | Go | Go | Go | Go |

TABLE 4

| | | | Examples | | | Comparative Examples | | | | | | |
|---|---|---|---|---|---|---|---|---|---|---|---|---|
| Wood-based material | | | 28 | 29 | 30 | 31 | 32 | 33 | 34 | 35 | 36 | 37 |
| Composition | Wood-based | Parts by | 73 | 73 | 73 | 76 | 73 | 73 | 73 | 73 | 73 | 73 |
| | element | weight | | | | | | | | | | |
| | Bonding | Examples | 9 | 10 | 11 | 12 | 12 | 13 | 14 | 15 | 16 | 17 |
| | composition | | | | | | | | | | | |
| | | Parts by | 27 | 27 | 27 | 24 | 27 | 27 | 27 | 27 | 27 | 27 |
| | | weight | | | | | | | | | | |
| Molding | Temperature | ° C. | 170 | 170 | 170 | 170 | 170 | 170 | 170 | 170 | 170 | 170 |
| conditions | Time | Minutes | 9 | 9 | 9 | 9 | 9 | 9 | 9 | 9 | 9 | 9 |
| | Pressure | MPa | 4 | 4 | 4 | 4 | 4 | 4 | 4 | 4 | 4 | 4 |

| | | | | | | | | | | | |
|---|---|---|---|---|---|---|---|---|---|---|---|
| Performances | Bending strength | 20.4 | 20.1 | 14.3 | 13.8 | 16.5 | 15.7 | 15.5 | 15.6 | 16.2 | 14.3 |
| | (N/mm²) | A | A | A | B | A | B | B | B | B | B |
| | Bending strength | 8.8 | 8.5 | 7.1 | * | 4.5 | * | 2.5 | 1.5 | 1.3 | * |
| | under wet condition | A | A | A | C | C | C | C | C | C | C |
| | (N/mm²) | | | | | | | | | | |
| | Water-absorption | 5.3 | 10.6 | 4.0 | 14.3 | 9.6 | 24.5 | 10.6 | 15.5 | 15.8 | 22.5 |
| | thickness expansion | A | B | A | C | B | C | B | C | C | C |
| | coefficient (%) | | | | | | | | | | |
| | Peeling strength | 1.4 | 1.5 | 1.3 | 0.5 | 0.8 | 0.8 | 0.9 | 0.7 | 0.8 | 0.6 |
| | (N/mm²) | Go | Go | Go | Go | Go | Go | Go | Go | Go | Go |

* indicates “Collapse”.

As shown in Tables 3 and 4, the wood-based materials of Examples 18 to 30 produced by using the aqueous bonding compositions of Examples 1 to 11 were excellent in bending strength, bending strength under wet condition, and peeling strength, and exhibited a small water-absorption thickness expansion coefficient, regardless of being molded at a comparatively low temperature of 170° C. These wood-based materials were also excellent in balance among these performances. Therefore, the bonding composition according to the present invention can be suitably used and applied to a wood-based element so as to produce a wood-based material.

To the contrary, as shown in Table 4, wood-based materials of Comparative Examples 31 to 37 produced by using the aqueous bonding compositions of Comparative Examples 12 to 17 have problems with any one of bending strength, bending strength under wet condition, peeling strength, and water-absorption thickness expansion coefficient. These wood-based materials are inferior in performances under wet condition. Therefore, the bonding compositions of Comparative Examples are unsatisfactory to produce the wood-based material.

These results revealed that the aqueous bonding composition comprising the above-mentioned three components (A) to (C) is useful to bond a wood-based element (raw material), and an excellent wood-based material can be produced (or molded) by producing (or molding) the wood-based element using the same.

### INDUSTRIAL APPLICABILITY

The present invention can provide an aqueous bonding composition which is useful for bonding a wood-based element. A wood-based material can be suitably produced by molding a wood-based element using the aqueous bonding composition according to the present invention.

1: An aqueous bonding composition comprising:
(A) a sugar syrup selected from waste molasses, ice molasses or crude saccharides;
(B) an inorganic acid ammonium salt selected from ammonium sulfate, ammonium chloride, ammonium hydrogen phosphate or ammonium dihydrogen phosphate; and
(C) a metal salt selected from potassium salt, calcium salt, sodium salt or magnesium salt.

2. (canceled)

3. (canceled)

4: The aqueous bonding composition according to claim 1, wherein the metal salt (C) comprises at least one selected from magnesium chloride, potassium chloride, and sodium chloride.

5: A wood-based material comprising the aqueous bonding composition according to claim 1 and a wood-based element selected from sawn board, veneer, wood-based strand, wood-based chip or wood-based fiber and vegetable fiber.

6: The wood-based material of claim 5, which is a particle board, fiber board, laminated woods, plywood, particle board or MDF.

7: The aqueous bonding composition according to claim 1 further comprising a thickener, preservative, mildew proofing agent, rust preventive or dispersion stabilizer.
